(19) United States
(12) Patent Application Publication
(10) Pub. No.: US 2024/0275635 A1
(43) Pub. Date: Aug. 15, 2024

(54) MULTI-STAGE PACKET PROCESSING PIPELINE FOR A SINGLE TUNNEL INTERFACE

(71) Applicant: Microsoft Technology Licensing, LLC, Redmond, WA (US)

(72) Inventors: Srinivas KORIPELLA, Hyderabad (IN); James Matthew Hamilton OAKLEY, Holliston, WA (US); Kalin Georgiev TOSHEV, Redmond, WA (US); Neil Adam JACOBSON, Acton, MA (US)

(21) Appl. No.: 18/569,555

(22) PCT Filed: May 11, 2022
(86) PCT No.: PCT/US2022/028658

§ 371 Date: Dec. 12, 2023

(30) Foreign Application Priority Data
Jun. 14, 2021 (IN) 202141026513

(51) Int. Cl. H04L 12/46

(52) U.S. Cl. CPC H04L 12/4633

(57) ABSTRACT

Multi-stage packet processing pipeline for a single tunnel interface. A computer system identifies a single tunnel interface that is associated with an operating environment, and identifies a plurality of packet processing stages. Each stage comprises at least one rule specifying packets to which the stage applies, and logic configured to process each packet received by the stage. The computer system composes the stages into a packet processing pipeline by registering a union of the stages' rules with the tunnel interface, and by arranging the stages into a linear pipeline. The pipeline connects an upstream connector of an initial stage to the tunnel interface, and connects upstream and downstream connectors from each pair of adjacent stages.

### BACKGROUND

Most contemporary operating systems enforce restrictions on client applications, including limiting the ability of those client applications to access operating system resources. This is particularly true within the operating systems of predominant mobile platforms, such as iOS from APPLE, INC. of Cupertino, CA and Android from GOOGLE LLC of Mountain View, CA.

Among the restrictions that some operating systems (such as iOS and Android) enforce on client applications is a limited ability to create and/or use operating system-level tunnel interfaces, which are useful for enabling client applications-such as Virtual Private Network (VPN) applications to receive and process outbound Internet Protocol (IP) packets originating from other client applications or operating system components and to provide incoming packets to the operating system. In particular, most contemporary predominant mobile platform operating systems only provide a single tunnel interface for use by all client applications, and only permit a single client application to attach to that tunnel interface at any given time. Among the reasons for enforcing this limitation is a desire to avoid the complexity of dealing with routing configurations that involve multiple tunnel interfaces. As such, within some contexts-such as mobile platforms—there is a limited ability for client applications to utilize tunnel interfaces.

### BRIEF SUMMARY

At least some embodiments described herein enable multiple client applications to utilize a single tunnel interface by providing and/or operating a multi-stage packet processing pipeline that operates on top of a single tunnel interface. In particular, embodiments compose an ordered, linear pipeline comprising a plurality of packet processing stages, with the initial stage in the pipeline being configured to attach to an operating system-provided tunnel interface. Each stage comprises at least one rule defining which packets the stage would like to have routed to the stage (e.g., by an identification of destination network addresses and/or address ranges), and a union of these rules is registered with the tunnel interface so that packets requested by these stages are routed to the tunnel interface. Each stage is configured to consume a packet received upstream on the pipeline, and/or pass the packet downstream on the pipeline to the next stage. In this configuration, a single client application (i.e., the initial stage) attaches to the tunnel interface, but by configuring each stage to consume and/or pass packets downstream on the pipeline, multiple client applications are enabled to use this single tunnel interface. Thus, the embodiments described herein provide a technical effect of enabling a single limited use tunnel interface (such as those that are available to client applications running on predominant mobile platform operating systems) to be utilized by multiple client applications.

In some embodiments, methods, systems, and computer program products are directed to applying a multi-stage packet processing pipeline to a tunnel interface. A computer system identifies a single tunnel interface that is associated with an operating environment of the computer system, and identifies a plurality of packet processing stages. Each packet processing stage comprises at least one rule specifying packets to which the packet processing stage applies, and logic configured to process each packet received by the packet processing stage. The computer system composes the plurality of packet processing stages into a packet processing pipeline. The composing includes identifying a union of rules specifying packets to which the plurality of packet processing stages apply, and registering the union of rules with the single tunnel interface. The composing also comprises arranging the plurality of packet processing stages into a linear pipeline. The arranging includes connecting an upstream connector of an initial packet processing stage to the single tunnel interface, and for each pair of adjacent packet processing stages, connecting a respective downstream connector of an upstream packet processing stage in the pair to a respective upstream connector of a downstream packet processing stage processing stage in the pair.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates providing and/or operating a multi-stage packet processing pipeline for a single tunnel interface;

FIG. 2 illustrates a flowchart of forming and registering a union of packet processing stage rules;

FIG. 3 illustrates a flowchart processing a packet downstream (forward) in a packet processing pipeline;

FIG. 4 illustrates a flowchart processing a packet upstream (reverse) in a packet processing pipeline; and

FIG. 5 illustrates a flow chart of an example method for applying a multi-stage packet processing pipeline to a single tunnel interface.

### DETAILED DESCRIPTION

At least some embodiments described herein enable multiple client applications to utilize a single tunnel interface by providing and/or operating a multi-stage packet processing pipeline that operates on top of a single tunnel interface. These embodiments compose an ordered, linear pipeline comprising a plurality of packet processing stages, with the initial stage in the pipeline being configured to attach to a tunnel interface. Each stage comprises at least one rule defining which packets the stage would like to have routed to the stage, and a union of these rules is registered with the tunnel interface. Each stage consumes a packet received upstream on the pipeline, passes the packet downstream on the pipeline to the next stage, or both. In this configuration, multiple client applications are enabled to use a single tunnel interface via a single application that attaches to the tunnel interface.

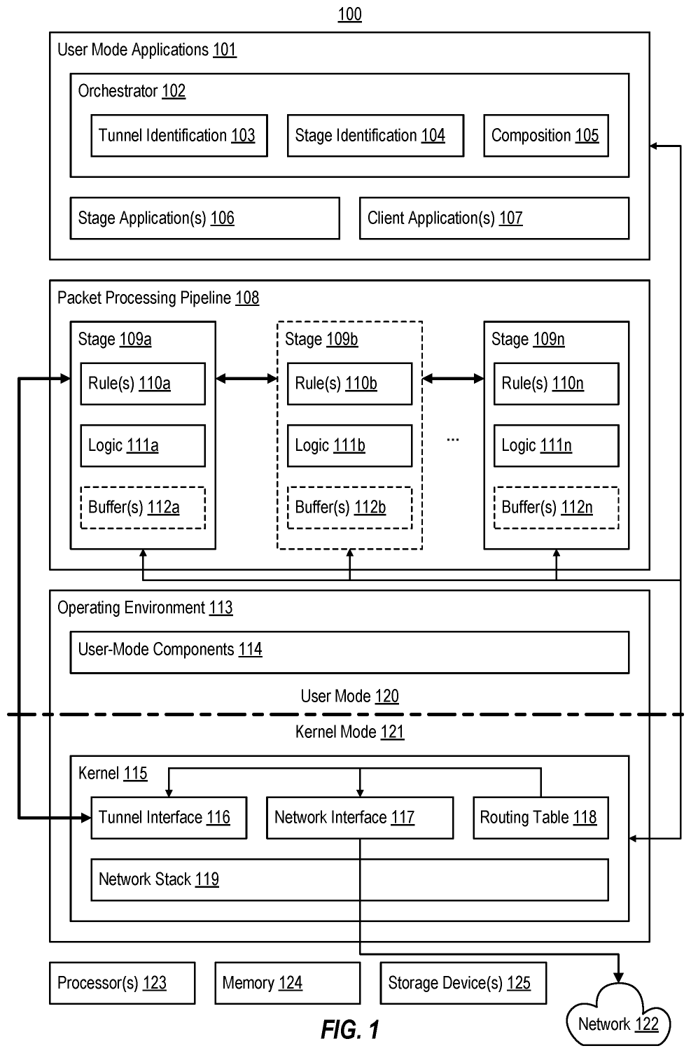

FIG. 1 illustrates an example computing environment 100 that facilitates providing and/or operating a multi-stage packet processing pipeline for a single tunnel interface. In embodiments, the computing environment 100 is implemented on a special-purpose or general-purpose computer system, discussed infra, and which comprises at least one processor 123, memory 124, and at least one storage device 125. As shown, computing environment 100 comprises an operating environment 113, such as an operating system that executes on the processor(s) 123. As illustrated, the operating environment 113 provides a user mode 120 and a kernel mode 121. Within the user mode 120, the operating environment 113 operates user mode components 114. Within the kernel mode 121, the operating environment 113 operates a kernel 115 that provides, among other things, a tunnel interface 116, a network interface 117 (or a plurality of network interfaces), and a routing table 118—each of which is associated with (or is part of) a network stack 119. While FIG. 1 provides one possible arrangement of operating environment 113, it will be appreciated by one of ordinary skill in the art that other arrangements of operating environment 113, including the components contained therein, are possible and each of those arrangements are within the scope of the present disclosure.

With reference to the kernel 115, the tunnel interface 116 is virtual software-based network device that is simulated by the processor(s) 123. In some embodiments, the tunnel interface 116 simulates a network layer device operating in layer 3 of the Open Systems Interconnection (OSI) model, and carries IP packets. One example of a simulated network layer device is the TUN device available on many operating systems. In other embodiments, the tunnel interface 116 simulates a link layer device operating in layer 2 of the OSI model, and carries Ethernet frames. One example of a simulated link layer device is the TAP device available on many operating systems. In embodiments, packets sent by the operating environment 113 via the tunnel interface 116 are delivered to a user space program that attaches itself to the tunnel interface 116. This user space program may also pass packets into the tunnel interface 116, and in this case the tunnel interface 116 delivers (or “injects”) these packets into the network stack 119, thus emulating their reception from an external source. The network interface 117, on the other hand, is a software interface to a physical network device that sends and receives data on a network 122. When IP packets enter the network stack 119, the routing table 118 defines to which interface (e.g., tunnel interface 116, network interface 117, etc.) those network packets are to be routed. In embodiments, the routing table 118 defines routes based associating interfaces with destination IP networks.

Like many contemporary operating systems, operating environment 113 provide only a single tunnel interface 116 that is accessible to applications (e.g., user mode applications 101) running on top of the operating environment 113, and only permits one of those user mode applications 101 to attach to that tunnel interface 116 at any given time. As mentioned, among the reasons for enforcing this limitation is a desire to avoid the complexity of dealing with routing configurations that involve multiple tunnel interfaces. In embodiments, the tunnel interface 116 is accessible directly by one of user mode applications 101 by reference to a handle, such as a tunnel file descriptor. Additionally, or alternatively, in embodiments, the tunnel interface 116 is accessible indirectly by one of user mode applications 101 via an application programming interface (API), such as a VPN API, which wraps the handle.

In order to overcome the limitation that operating environment 113 provides only a single tunnel interface 116, and that operating environment 113 only permits one of the user mode applications 101 to attach to that tunnel interface 116 at any given time, the user mode applications 101 comprise an orchestrator 102 and stage application(s) 106. While the orchestrator 102 and the stage application(s) 106 are illustrated as separate, in embodiments the orchestrator 102 and at least one of the stage application(s) 106 are combined into a common application. In general, the orchestrator 102 establishes a packet processing pipeline 108 that attaches to the tunnel interface 116, and that passes traffic through a plurality of packet processing stages (stages 109), each of which is a user mode application. Thus, the orchestrator 102 enables the tunnel interface 116 to be concurrently shared by a plurality of user mode applications.

As illustrated, the orchestrator 102 includes a tunnel identification component 103, which operates to identify the tunnel interface 116. The manner with which the tunnel identification component 103 identifies the tunnel interface 116 can vary depending on design and implementation of the operating environment 113, but in one example the tunnel identification component 103 identifies the tunnel interface 116 by identifying a handle (e.g., a tunnel file descriptor stored in memory 124 for a TUN or TAP interface) to the tunnel interface 116. In embodiments, this may include the tunnel identification component 103 requesting that the operating environment 113 initialize the tunnel interface 116 on behalf of the orchestrator 102 (e.g., via a call to the user mode components 114).

As illustrated, the orchestrator 102 also includes a stage identification component 104, which operates to identify a plurality of packet processing stages (stages 109) provided as components of the stage application(s) 106. Thus, in embodiments, each of the stages 109 comprises computer-executable instructions stored in memory 125 and/or storage device(s) 125. In embodiments, each of stages 109 is associated with a name or other identifier, such as a file name (e.g., for an executable binary image), a module name, a class name, a function name, etc. Thus, in embodiments, the stage identification component 104 identifying each stage comprises the stage identification component 104 identifying a name or other identifier corresponding to that stage. In embodiments, the stage identification component 104 identifies all of these stages 109 from a single one of the stage application(s) 106, while in other embodiments the stage identification component 104 identifies these stages 109 across two or more of the stage application(s) 106. In embodiments, each of the stage application(s) 106 provides a list of at least one stage provided by the stage application, such as in reference to a name or other identifier (e.g., file name, module name, class name, function name, etc.), and the stage identification component 104 identifies the stages 109 from at least one of these lists.

In embodiments, each of stages 109 is executable code (e.g., a user mode client application) that executes at the processor(s) 123, and that operates to receive and process packets (e.g., IP datagrams). Upon receiving a packet at an upstream connector, each stage consumes the packet, outputs the packet at a downstream connector, or consumes and also outputs the packet. In embodiments, stages 109 comprise at least one of a first stage that performs packet inspection and filtering (e.g., to provide firewall functionality), a second stage that performs split IP tunneling (e.g., to separate traffic destined for a VPN from traffic not destined to the VPN), a third stage that provides single sign-on (SSO), a fourth stage that performs packet observation (e.g., domains name system inspection, packet snooping, etc.), a fifth stage that establishes a VPN tunnel, and the like.

As illustrated, the orchestrator 102 also includes a composition component 105, which operates to linearly arrange the stages identified by the stage identification component 104 into an ordered packet processing pipeline 108 by connecting the downstream and upstream connectors of adjacent stages, and by connecting an upstream connector of the first stage of the pipeline to the tunnel interface 116 (i.e., attaching the first stage to the tunnel interface 116). As shown, for example, the packet processing pipeline 108 comprises two or more stages (i.e., stages 109) that are arranged in a linear pipeline. These stages 109 are illustrated as an initial stage (stage 109a), an ending stage (stage 109n), and zero or more intermediary stages (e.g., stage 109b). Ellipsis indicate that there can be any number of intermediary stages. As indicated by an arrow between stage 109a and the tunnel interface 116, the composition component 105 connects an upstream connector of stage 109a to the tunnel interface 116. As indicated by an arrow between stage 109a and stage 109b, and an arrow between stage 109b and stage 109n, the composition component 105 connects downstream and upstream connectors of adjacent stages in the packet processing pipeline 108. For example, if stage 109b is present, and no other intermediary stage is present, then the composition component 105 connects a downstream connector of stage 109a with an upstream connector of stage 109b and connects a downstream connector of stage 109b with an upstream connector of stage 109n. If no intermediary stage is present, then the composition component 105 connects the downstream connector of stage 109a with the upstream connector of stage 109n. While the composition component 105 can use any available mechanism to connect the stages 109, in embodiments the composition component 105 uses sockets, such as UNIX domain sockets, to connect stages 109.

As shown, each of the stages 109 comprises at least one rule (i.e., rule(s) 110a for stage 109a, rule(s) 110b for stage 109b, and rule(s) 110n for stage 109n). In embodiments, each stage's rule(s) specifies packets to which the packet processing stage applies. Stated differently, each stage's rule(s) specifies which packets that stage would like to be routed to the stage. In embodiments, a stage's rule(s) specify at least one range of destination IP addresses (e.g., as a list of IP addresses and/or IP networks), thereby requesting any packets addressed to an IP address within those range(s) to be routed to the stage.

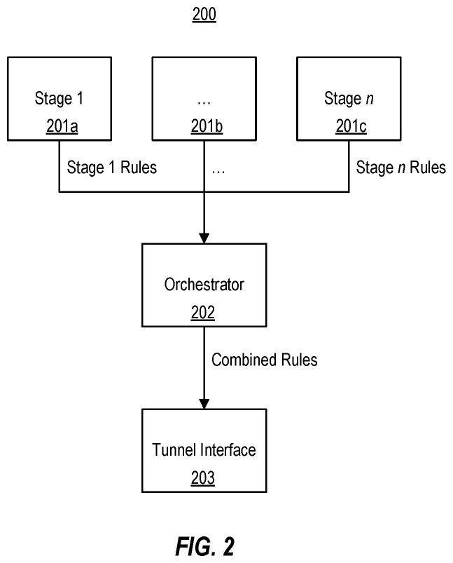

In embodiments, for each of the stages 109 being included in the packet processing pipeline 108, the composition component 105 accesses those stage's rule(s), and then forms a union of those rules. The composition component 105 then registers this union with the tunnel interface 116. For example, FIG. 2 illustrates a flowchart 200 of forming and registering a union of packet processing stage rules. In particular, FIG. 2 shows a plurality of stages 201 (i.e., 201a, 201b, 201c), which correspond to stages 109 in FIG. 1. These stages 201 are connected by plural arrows to an orchestrator 202 (i.e., orchestrator 102), with arrow labels indicating that the orchestrator 202 accesses at least one rule for each stage. The orchestrator 202 is then connected by a single arrow to a tunnel interface 203 (i.e., tunnel interface 116), with an arrow label indicating that the orchestrator 202 (i.e., using composition component 105) registers a combination (i.e., union) of these rules with the tunnel interface 203. In embodiments, the composition component 105 registers a union of each stages' rule(s) with the tunnel interface 116 by associating, within the routing table 118, at least one range of IP addresses with the tunnel interface 116 (e.g., via a call to the user mode components 114).

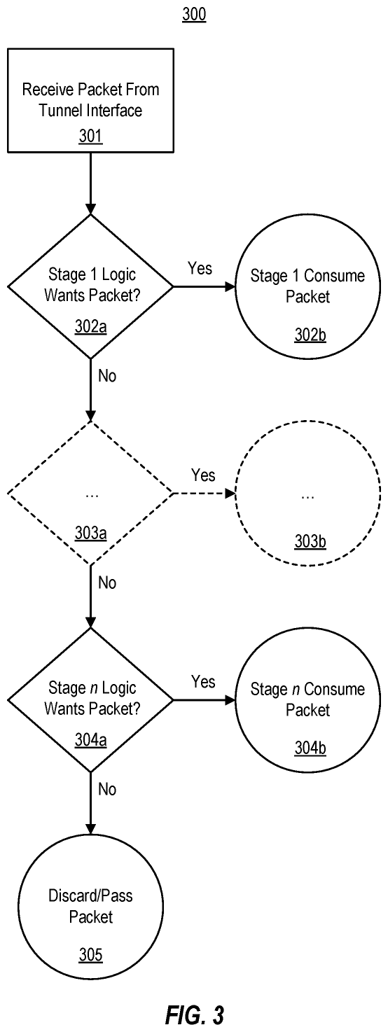

As shown, each of the stages 109 also comprise logic 111 (i.e., logic 111a for stage 109a, logic 111b for stage 109b, and logic 111n for stage 109n). In embodiments, each stage's logic 111 processes each packet received at the stage's upstream connector, and consumes the packet and/or passes the packet to the stage's downstream connector. For example, FIG. 3 illustrates a flowchart 300 of processing a packet downstream (forward) in a packet processing pipeline. In FIG. 3, flowchart 300 begins at a step 301 where a packet is received from a tunnel interface. In an example, one of client application(s) 107 sends a packet to the network stack 119; then, based on the routing table 118, that packet is routed to the tunnel interface 116. The tunnel interface 116, in turn, passes the packets to an upstream connector of the first stage of the packet processing pipeline 108 (i.e., stage 109a). Flowchart 300 then proceeds to step 302a, where the first stage's logic determines if it wants that packet. If so, (i.e., “yes” from step 302a) the first stage consumes the packet at step 302b and flowchart 300 ends; otherwise (i.e., “no” from step 302a), the first stage outputs the packet on its downstream connector. Flowchart 300 shows that, if the first stage outputs a packet on its downstream connector, then the same logic applies as the packet passes to at least one downstream stage (e.g., step 303a and step 303b for each intermediary stage, and step 304a and step 304b for a last (n^{th}) stage. Notably, if the packet reaches the last stage, then in step 304a the last stage can either discard that packet, or pass the packet (e.g., to one of application(s) 107, to network interface 117, etc.) in step 305.

When a stage consumes a packet, the action(s) it takes to consume the packet can vary, depending on the nature of the stage, and can include (as examples) transforming the packet (e.g., encrypting the packet, modifying fields in the packet, etc.), sending the packet towards a software component (e.g., kernel 115, client application(s) 107), sending the packet towards a physical network interface (e.g., network interface 117), and/or discarding the packet. In one example, the stage is a VPN application and the stage sends the packet down a VPN tunnel established over the network interface 117. In another example, the stage is a firewall application and the stage discards the packet. In another example, the stage is a packet observation application and the stage logs the packet and also outputs the packet on the stage's downstream connector. In embodiments, any given stage can both consume and pass a packet.

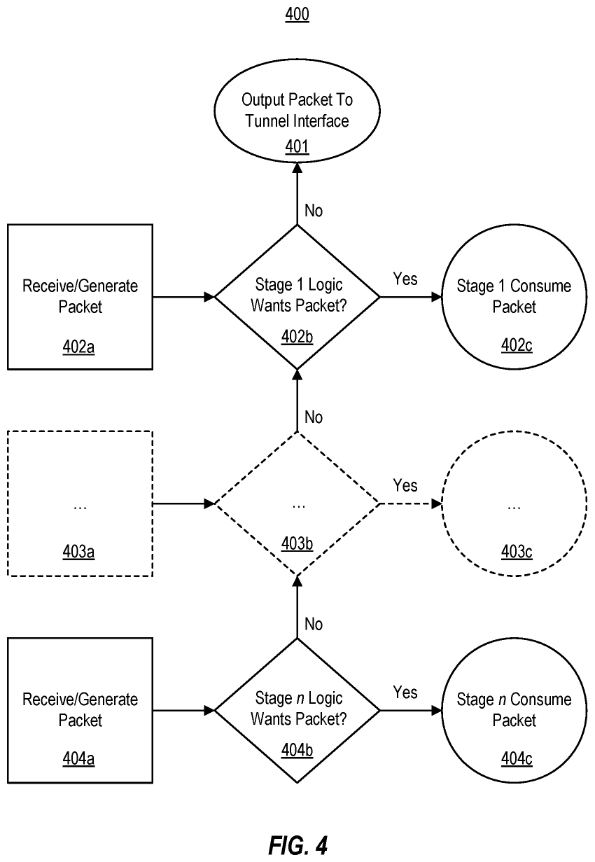

While FIG. 3 illustrated a packet traversing downstream (forward) through the packet processing pipeline 108, in some embodiment a packet is introduced at some stage in the packet processing pipeline 108 (rather than by the tunnel interface 116), and that packet traverses upstream (reverse) through the packet processing pipeline 108. In these embodiments, each stage's logic 111 may simply pass any packet received at the stage's downstream connector to the stage's upstream connector. Alternatively, each stage's logic 111 may process each packet received at the stage's downstream connector, and consume the packet and/or pass the packet to the stage's upstream connector. FIG. 4 illustrates a flowchart 400 of processing a packet upstream (reverse) in a packet processing pipeline. In FIG. 4, flowchart 400 begins when any stage receives or generates a packet (i.e., step 402a, step 403a, or step 404a). In some embodiments, the stage that receives or generates a packet simply outputs the packet on its upstream connector. In other embodiments, and as shown in flowchart 400, the stage that receives or generates a packet may use its logic to determine if it wants that packet (step 402b, step 403b, or step 404b). If so, that stage consumes the packet (step 402c, step 403c, or step 404c) and flowchart 400 ends; otherwise, that stage outputs the packet on its upstream connector where it is processed by an upstream stage, and/or it is output to the tunnel interface 116 (step 401). In one example, the stage is a VPN application and the stage receives a packet from a VPN tunnel established over the network interface 117, and the forwards the packet upstream on the packet processing pipeline 108 towards the tunnel interface 116 (and client application(s) 107). In another example, the stage is a firewall application that generates a rejection packet and forwards the rejection packet upstream on the packet processing pipeline 108 towards the tunnel interface 116 (and client application(s) 107).

As shown in FIG. 1, in embodiments, at least one of stages 109 comprises buffer(s) 112 (i.e., at least one of buffer(s) 112a for stage 109a, buffer(s) 112b for stage 109b, or buffer(s) 112n for stage 109n). In embodiments, when a stage comprises buffer(s) 112, the stage's logic 111 can operate on a plurality of packets stored in the stage's buffer(s) 112 as a group, rather than on individual packets. In particular when receiving a packet at an upstream or downstream connector, a stage can store that packet the stage's buffer 112. Then, when plural packets have been stored in the buffer 112, the stage's logic 111 can operate to decide to whether to pass or consume those packets as a group. Thus, while flowchart 300 and flowchart 400 referred to consuming/passing a single packet, in embodiments these flowcharts consume/pass plural packets at once. In embodiments, a stage's logic 111 can also generate and inject new packets into the stage's buffer 112, modify packets within the stage's buffer 112, discard/delete individual packets from the stage's buffer 112, or arrange packets that arrived out-of-order.

In embodiments, the orchestrator 102 applies at least one rule when identifying the stages 109 and/or when composing the stages 109 into the packet processing pipeline 108. In embodiments, the orchestrator 102 uses these rules to dynamically change or update the packet processing pipeline 108 as conditions (e.g., time of day, geographical location, connected network(s), etc.) changes.

For example, in some embodiments the stage identification component 104 uses at least one rule when identifying stages to include in the packet processing pipeline 108. In an example, the stage application(s) 106 may include a stage that is under a licensing restriction that only permits the stage to be used when a licensing agreement is active; in this example, the stage identification component 104 may determine if the licensing agreement is active, and include or omit the stage based on that determination. In some embodiments, the stage identification component 104 chooses one stage (e.g., a limited functionality/demo stage) in favor other another stage (e.g., a full functionality/fully licensed stage) based on a licensing determination. In another example, the stage application(s) 106 may include a stage that is under a licensing restriction that only permits the stage to be used in certain geographies; in this example, the stage identification component 104 may determine a current geography (e.g., based on IP address, GPS coordinates, etc.), and include or omit the stage based on that determination. In some embodiments, the stage identification component 104 chooses one stage (e.g., a “foreign geography” stage) in favor other another stage (e.g., a “domestic geography” stage) based on a geographical determination. In another example, the stage application(s) 106 may include a stage that is under a licensing restriction that only permits the stage to be used on certain networks; in this example, the stage identification component 104 may determine a current network (e.g., based on IP address, connected Wi-Fi network, etc.), and include or omit the stage based on that determination. In some embodiments, the stage identification component 104 chooses one stage (e.g., a personal VPN stage) in favor other another stage (e.g., a business VPN stage) based on a network determination. In another example, the composition component 105 additionally, or alternatively, uses at least one rule to determine an ordering of stages in the packet processing pipeline 108, including potentially resolving conflicts between stages. In an example, the stage application(s) 106 may include a firewall stage and a VPN stage, and the composition component 105 uses rules to determine that the firewall stage should be ordered prior to the VPN stage in the packet processing pipeline 108. In another example, the stage application(s) 106 may request use conflicting domain name system (DNS) servers, and the composition component 105 uses rules to choose an ordering of those DNS servers in order to resolve the conflict.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed. In embodiments, method 500 is embodied as computer-executable instructions (e.g., stored on memory 124 and/or storage device(s) 125) that are executable by a processor (e.g., processor(s) 123) to cause a computer system to perform method 500.

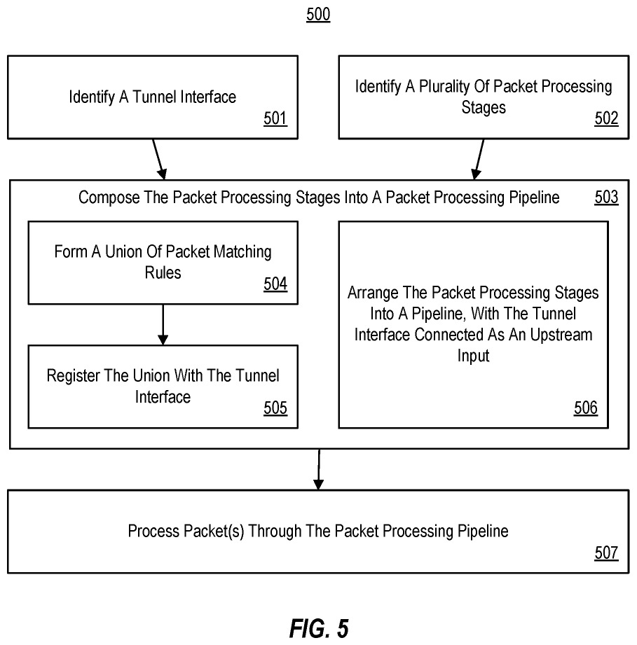

FIG. 5 illustrates a flow chart of an example method 500 for applying a multi-stage packet processing pipeline to a single tunnel interface. Method 500 will be described with respect to the components and data of computing environment 100.

Method 500 comprises an act 501 of identifying a tunnel interface. In some embodiments, act 501 comprises identifying a single tunnel interface that is associated with an operating environment of the computer system. In an example, the tunnel identification component 103 executes at the processor(s) 123 to identify tunnel interface 116. In some embodiments this includes the tunnel identification component 103 requesting that the operating environment 113 initialize the tunnel interface 116 (e.g., via a call to the user mode components 114). In some embodiments, the tunnel identification component 103 identifies a handle (e.g., a tunnel file descriptor stored in memory 124 for a TUN or TAP interface) to the tunnel interface 116, such that identifying the tunnel interface comprises identifying a handle. In other embodiments, the tunnel identification component 103 identifies and API wrapper around a handle, such that identifying the tunnel interface comprises identifying an API wrapper.

Method 500 comprises an act 502 of identifying a plurality of packet processing stages. In some embodiments, act 502 comprises identifying a plurality of packet processing stages, each packet processing stage comprising at least one rule specifying packets to which the packet processing stage applies, and logic configured to process each packet received by the packet processing stage. In an example, the stage identification component 104 executes at the processor(s) 123 to identify a plurality of stages 109 that are each defined by application(s) 106. In embodiments, the stage identification component 104 identifies each stage as an executable component (i.e., computer-executable instructions) stored in memory 125 and/or storage device(s) 125. As shown in FIG. 1, in an example the stages 109 include stage 109a as an initial stage, stage 109n as a final stage, and potentially at least one intermediary stage (stage 109b). As illustrated in FIG. 1, and as explained, each of stages 109 comprises at least one rule (i.e., rules 110) for identifying which packets are requested by the stage, and logic 111 for determining whether to consume a packet or pass the packet to a next stage. In embodiments the stages 109 are configured to receive and operate on packets comprising IP datagrams.

As discussed, in some embodiments the stage identification component 104 identifies all of these stages 109 from a single one of the stage application(s) 106, such that identifying the plurality of packet processing stages in act 502 comprises identifying the plurality of packet processing stages from a single application. In other embodiments, the stage identification component 104 identifies these stages 109 across two or more of the stage application(s) 106, such that identifying the plurality of packet processing stages in act 502 comprises identifying the plurality of packet processing stages from a plurality of applications.

As discussed, in embodiments a stage's rule(s) specifies at least one range of destination IP addresses (e.g., as a list of IP addresses and/or IP networks), thereby requesting any packets addressed to an IP address within those range(s). Thus, in some embodiments of act 502, each rule identifies at least one network address.

As demonstrated in connection with FIG. 3 and FIG. 4, a stage's logic 111 can cause the stage to consume a packet and/or cause the stage to pass the packet upstream or downstream on the packet processing pipeline 108. Thus, in embodiments, the stage's logic causes the packet processing stage to consume the packet, and/or causes the packet processing stage to output the packet on the packet processing pipeline. In embodiments, the stage's logic consumes a packet by performing at least one of transforming the packet, sending the packet towards a software component, sending the packet towards a physical network interface, or discarding the packet. As discussed, in embodiments at least one of stages 109 may comprises buffer(s) 112, which can store a plurality of packets for processing as a group by the stage's logic 111. Thus, in embodiments, a particular packet processing stage comprises a packet buffer, and the logic of the particular packet processing stage operates on a plurality of packets stored in the packet buffer. In embodiments, the logic of the particular packet processing stage performs at least one of injecting a packet into the packet buffer, removing a packet from the packet buffer, or modifying a packet within the packet buffer.

As discussed, in embodiments, the stage identification component 104 uses at least one rule when identifying stages to include in the packet processing pipeline 108, such as rules based on licensing status, geography, or a currently connected network. Thus, in some embodiments, identifying the plurality of packet processing stages in act 502 comprises selecting at least one of the plurality of packet processing stages based on at least one of licensing status, geo-location, or a computer system attribute.

Method 500 comprises an act 503 of composing the packet processing stages into a packet processing pipeline. In some embodiments, act 503 comprises composing the plurality of packet processing stages into a packet processing pipeline. In an example, the composition component 105 executes at the processor(s) 123 to linearly compose stages 109 into packet processing pipeline 108.

As shown, act 503 comprises an act 504 of forming a union of packet matching rules. In some embodiments, act 504 comprises identifying a union of rules specifying packets to which the plurality of packet processing stages apply (e.g., based on each stage's at least one rule). In an example, the composition component 105 executes at the processor(s) 123 to form a union of the rules 110 of stages 109 (e.g., rule(s) 110a for stage 109a, rule(s) 110b for stage 109b, and rule(s) 110n for stage 109n). In embodiments in which each rule identifies at least one range network addresses, the union of rules identifies a union of a plurality of ranges of network addresses. In embodiments, each range of network addresses comprises at least one network address.

As shown, act 503 comprises an act 505 of registering the union with the tunnel interface. In some embodiments, act 505 comprises registering the union of rules with the single tunnel interface. In an example, the composition component 105 executes at the processor(s) 123 to register the union formed in act 504 with the tunnel interface 116. In embodiments, registering the union with the tunnel interface 116 comprises associating, within the routing table 118, at least one range of IP addresses with the tunnel interface 116 (e.g., via a call to the user mode components 114). Flowchart 200 provides an illustration of act 504 and act 505, where stages 201 are connected by plural arrows to orchestrator 202, with arrow labels indicating that the orchestrator 202 receives at least one rule for each stage. The orchestrator 202 is then connected by a single arrow to tunnel interface 203, with an arrow label indicating that the orchestrator 202 registers a combination (i.e., union) of these rules with the tunnel interface 203.

As shown, act 503 comprises an act 506 of arranging the packet processing stages into a pipeline, with the tunnel interface connected as an upstream input. In some embodiments, act 506 comprises arranging the plurality of packet processing stages into a linear pipeline, including connecting an upstream connector of an initial packet processing stage to the single tunnel interface; and, for each pair of adjacent packet processing stages, connecting a respective downstream connector of an upstream packet processing stage in the pair to a respective upstream connector of a downstream packet processing stage processing stage in the pair. In an example, the composition component 105 executes at the processor(s) 123 to arrange the stages 109 identified by the stage identification component 104 in act 502 into packet processing pipeline 108. This includes the composition component 105 connecting an upstream connector of stage 109a to the tunnel interface 116 and connecting downstream and upstream connectors of adjacent stages in the packet processing pipeline 108.

As discussed, in embodiments the composition component 105 uses sockets (e.g., UNIX domain sockets) to connects stages. Thus, in some embodiments of act 506, for each pair of adjacent packet processing stages, connecting the respective downstream connector of the upstream packet processing stage in the pair to the respective upstream connector of the downstream packet processing stage processing stage in the pair comprises the composition component 105 establishing a respective socket between the respective downstream connector and the respective upstream connector.

As discussed, in embodiments, the composition component 105 uses at least one rule to determine an ordering of stages in the packet processing pipeline 108, including potentially resolving conflicts (e.g., conflicting DNS servers) between stages. Thus, in some embodiments, composing the plurality of packet processing stages into the packet processing pipeline in act 503 comprises at least one of determining an ordering of stages in the packet processing pipeline, or resolving a conflict.

In embodiments, method 500 also comprises an act 507 of processing packet(s) through the packet processing pipeline. In some embodiments, act 507 comprises consuming a first packet received by the initial packet processing stage from the tunnel interface at the initial packet processing stage. In embodiments, the consumption is based on applying the logic of the initial packet processing stage. In an example, the tunnel interface 116 executes at the processor(s) 123 to pass a first packet to stage 109a, which is the initial stage of packet processing pipeline 108. Upon receiving this first packet (e.g., step 301 of flowchart 300), stage 109a uses logic 111a to determine that the first packet is to be consumed (e.g., “yes” from step 302a to step 302b in flowchart 300), and consume the packet. In some embodiments, act 507 also comprises outputting a second packet received by the initial packet processing stage from the tunnel interface downstream on the packet processing pipeline. In embodiments, the outputting is based on applying the logic of the initial packet processing stage. In an example, the tunnel interface 116 passes a second packet to stage 109a, which is the initial stage of packet processing pipeline 108. Upon receiving this second packet (e.g., step 301 of flowchart 300), stage 109a uses logic 111a to determine) that the second packet is to be output downstream to the next stage, such as stage 109b (e.g., “no” from step 302a to step 303a in flowchart 300), and output the packet. As discussed, a stage can both consume and output a packet. Thus, in some embodiments, act 507 also comprises at least one of outputting the first packet downstream on the packet processing pipeline, or consuming the second packet at the initial packet processing stage.

In embodiments in which the initial packet processing stage outputs a packet downstream, a downstream packet processing stage also uses its logic to determine whether to consume or pass the packet further downstream. Thus, in some embodiments, method 500 also comprises, receiving a packet at a subsequent packet processing stage (e.g., stage 109b), and applying the logic (e.g., logic 111b) of the subsequent packet processing stage to consume the packet by the subsequent packet processing stage, or output the packet downstream on the packet processing pipeline. As demonstrated in connection with flowchart 300, this process can continue until the packet is consumed by an intermediary stage, or until a final stage either discards or passes the packet (e.g., to one of application(s) 107, to network interface 117, etc.).

As demonstrated in connection with flowchart 400, it is also possible for a stage to introduce a packet and pass that packet upstream through the packet processing pipeline 108. Thus, in some embodiments of method 500, a particular packet processing stage introduces a third packet, and the particular packet processing stage outputs the third packet upstream on the packet processing pipeline. This packet can then be received and processed by an upstream packet processing stage. Thus, in some embodiments, method 500 also comprises receiving the third packet at a prior packet processing stage and applying the logic of the prior packet processing stage to consume the third packet by the prior packet processing stage, or output the third packet upstream on the packet processing pipeline.

Accordingly, the embodiments described herein enable multiple client applications to utilize a single tunnel interface by providing and/or operating a multi-stage packet processing pipeline that operates on top of a single tunnel interface. The embodiments compose an ordered, linear pipeline comprising a plurality of packet processing stages, with the initial stage in the pipeline being configured to attach to a tunnel interface, and with each stage being configured to consume a packet received upstream on the pipeline and/or pass the packet downstream on the pipeline to the next stage. This configuration uses a single client application (i.e., the initial stage) to attach to the tunnel interface, while enabling multiple client applications to use the tunnel interface. Thus, the embodiments described herein enable limited use tunnel interfaces (such as those that are available to client applications running on predominant mobile platform operating systems) to be utilized by multiple client applications. In embodiments, this avoids the complexity of dealing with routing rules for multiple tunnel interfaces.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, at least one processor (e.g., processor(s) 123) and system memory (e.g., memory 124), as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media (e.g., memory 124, storage device(s) 125) that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network (e.g., network 122) and/or data links which can be used to carry program code in the form of computer-executable instructions or data structures, and which can be accessed by a general-purpose or special-purpose computer system. A “network” is defined as at least one data link that enables the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed by at least one processor, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes at least one host that is each capable of running at least one virtual machine. During operation, virtual machines emulate an operational computing system, supporting an operating system and perhaps at least one other application as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Embodiments include a method, implemented at a computer system that includes a processor, for applying a multi-stage packet processing pipeline to a single tunnel interface. The method comprises identifying a single tunnel interface that is associated with an operating environment of the computer system. The method also comprises identifying a plurality of packet processing stages, with each packet processing stage comprising at least one rule specifying packets to which the packet processing stage applies, and logic configured to process each packet received by the packet processing stage. In embodiments, the rules in each of these packet processing stages provide a technical ability to identify which packets are desired by each packet processing stage. In embodiments, the logic in each of these packet processing stages provide a technical ability for each packet processing stage to process packets received by the stage, and to consume packet and/or pass the packet to a next stage. The method also comprises composing the plurality of packet processing stages into a packet processing pipeline, including identifying a union of rules specifying packets to which the plurality of packet processing stages apply, registering the union of rules with the single tunnel interface, and arranging the plurality of packet processing stages into a linear pipeline. In embodiments, forming a union of rules and registering that union with the tunnel interface, provides a technical improvement of ensuring that all packets desired by the stages are routed to the packet processing pipeline. In addition, in embodiments arranging the plurality of packet processing stages into a linear pipeline provides a technical improvement of creating a pathway through which packets associated with the tunnel interface can pass. Arranging the plurality of packet processing stages into the linear pipeline includes connecting an upstream connector of an initial packet processing stage to the single tunnel interface and, for each pair of adjacent packet processing stages, connecting a respective downstream connector of an upstream packet processing stage in the pair to a respective upstream connector of a downstream packet processing stage processing stage in the pair. In embodiments, connecting stage connectors of packet processing stage pairs enables packets to pass from stage to stage (in either direction) and connecting the initial packet processing stage to the single tunnel interface connects the packet processing pipeline to the single tunnel interface. This, in turn, provides a technical improvement of enabling a plurality of packet processing stages to interface with the single tunnel interface via the initial packet processing stage, overcoming the inherent limitations of the single tunnel interface.

In some embodiments, the method also comprises (e.g., based on applying the logic of the initial packet processing stage) consuming a first packet received by the initial packet processing stage from the tunnel interface at the initial packet processing stage, and outputting a second packet received by the initial packet processing stage from the tunnel interface downstream on the packet processing pipeline. In embodiments, consuming the first packet at the initial packet processing stage enables the initial packet processing stage to provide functionality such as VPN tunneling, packet filtering, packet inspection etc. with respect to the first packet. In embodiments, outputting the second packet downstream on the packet processing pipeline enables a downstream packet processing stage to consume the second packet to functionality such as VPN tunneling, packet filtering, packet inspection etc. with respect to the second packet.

Embodiments also include a computer system configured to apply a multi-stage packet processing pipeline to a single tunnel interface. The computer system comprises a processor and a hardware storage device that stores computer-executable instructions that are executable by the processor to cause the computer system to identify a single tunnel interface that is associated with an operating environment of the computer system. The computer-executable instructions are also executable by the processor to cause the computer system to identify a plurality of packet processing stages, each packet processing stage comprising at least one rule specifying packets to which the packet processing stage applies, and logic configured to process each packet received by the packet processing stage. In embodiments, the rules in each of these packet processing stages provide a technical ability to identify which packets are desired by each packet processing stage. In embodiments, the logic in each of these packet processing stages provide a technical ability for each packet processing stage to process packets received by the stage, and to consume packet and/or pass the packet to a next stage. The computer-executable instructions are also executable by the processor to cause the computer system to compose the plurality of packet processing stages into a packet processing pipeline, including identifying a union of rules specifying packets to which the plurality of packet processing stages apply, registering the union of rules with the single tunnel interface, and arranging the plurality of packet processing stages into a linear pipeline. In embodiments, forming a union of rules and registering that union with the tunnel interface, provides a technical improvement of ensuring that all packets desired by the stages are routed to the packet processing pipeline. In addition, in embodiments arranging the plurality of packet processing stages into a linear pipeline provides a technical improvement of creating a pathway through which packets associated with the tunnel interface can pass. Arranging the plurality of packet processing stages into the linear pipeline includes connecting an upstream connector of an initial packet processing stage to the single tunnel interface and, for each pair of adjacent packet processing stages, connecting a respective downstream connector of an upstream packet processing stage in the pair to a respective upstream connector of a downstream packet processing stage processing stage in the pair. In embodiments, connecting stage connectors of packet processing stage pairs enables packets to pass from stage to stage (in either direction) and connecting the initial packet processing stage to the single tunnel interface connects the packet processing pipeline to the single tunnel interface. This, in turn, provides a technical improvement of enabling a plurality of packet processing stages to interface with the single tunnel interface via the initial packet processing stage, overcoming the inherent limitations of the single tunnel interface

In some embodiments, the computer-executable instructions are also executable by the processor to cause the computer system to (e.g., based on applying the logic of the initial packet processing stage) consume a first packet received by the initial packet processing stage from the tunnel interface at the initial packet processing stage, and output a second packet received by the initial packet processing stage from the tunnel interface downstream on the packet processing pipeline. In embodiments, consuming the first packet at the initial packet processing stage enables the initial packet processing stage to provide functionality such as VPN tunneling, packet filtering, packet inspection etc. with respect to the first packet. In embodiments, outputting the second packet downstream on the packet processing pipeline enables a downstream packet processing stage to consume the second packet to functionality such as VPN tunneling, packet filtering, packet inspection etc. with respect to the second packet.

Embodiments also include a hardware storage device that stores computer-executable instructions that are executable by a processor to cause a computer system to apply a multi-stage packet processing pipeline to a single tunnel interface. The computer-executable instructions include instructions that are executable by the processor to cause the computer system to identify a single tunnel interface that is associated with an operating environment of the computer system. The computer-executable instructions are also executable by the processor to cause the computer system to identify a plurality of packet processing stages, each packet processing stage comprising at least one rule specifying packets to which the packet processing stage applies, and logic configured to process each packet received by the packet processing stage. In embodiments, the rules in each of these packet processing stages provide a technical ability to identify which packets are desired by each packet processing stage. In embodiments, the logic in each of these packet processing stages provide a technical ability for each packet processing stage to process packets received by the stage, and to consume packet and/or pass the packet to a next stage. The computer-executable instructions are also executable by the processor to cause the computer system to compose the plurality of packet processing stages into a packet processing pipeline, including identifying a union of rules specifying packets to which the plurality of packet processing stages apply, registering the union of rules with the single tunnel interface, and arranging the plurality of packet processing stages into a linear pipeline. In embodiments, forming a union of rules and registering that union with the tunnel interface, provides a technical improvement of ensuring that all packets desired by the stages are routed to the packet processing pipeline. In addition, in embodiments arranging the plurality of packet processing stages into a linear pipeline provides a technical improvement of creating a pathway through which packets associated with the tunnel interface can pass. Arranging the plurality of packet processing stages into the linear pipeline includes connecting an upstream connector of an initial packet processing stage to the single tunnel interface and, for each pair of adjacent packet processing stages, connecting a respective downstream connector of an upstream packet processing stage in the pair to a respective upstream connector of a downstream packet processing stage processing stage in the pair. In embodiments, connecting stage connectors of packet processing stage pairs enables packets to pass from stage to stage (in either direction) and connecting the initial packet processing stage to the single tunnel interface connects the packet processing pipeline to the single tunnel interface. This, in turn, provides a technical improvement of enabling a plurality of packet processing stages to interface with the single tunnel interface via the initial packet processing stage, overcoming the inherent limitations of the single tunnel interface.

In some embodiments, the computer-executable instructions are also executable by the processor to cause the computer system to (e.g., based on applying the logic of the initial packet processing stage) consume a first packet received by the initial packet processing stage from the tunnel interface at the initial packet processing stage, and output a second packet received by the initial packet processing stage from the tunnel interface downstream on the packet processing pipeline. In embodiments, consuming the first packet at the initial packet processing stage enables the initial packet processing stage to provide functionality such as VPN tunneling, packet filtering, packet inspection etc. with respect to the first packet. In embodiments, outputting the second packet downstream on the packet processing pipeline enables a downstream packet processing stage to consume the second packet to functionality such as VPN tunneling, packet filtering, packet inspection etc. with respect to the second packet.

In at least one embodiment, the first packet is output downstream on the packet processing pipeline. Additionally, or alternatively, in at least one embodiment the second packet is consumed at the initial packet processing stage. In at least one embodiment, the first packet is received at a subsequent packet processing stage, and the logic of the subsequent packet processing stage is applied to consume the first packet by the subsequent packet processing stage, or output the first packet downstream on the packet processing pipeline.

In at least one embodiment identifying the plurality of packet processing stages comprises identifying the plurality of packet processing stages from a single application, while in other embodiments identifying the plurality of packet processing stages comprises identifying the plurality of packet processing stages from a plurality of applications.

In at least one embodiment, each rule identifies at least one network address range. In these embodiments, the union of rules identifies a union of a plurality of ranges of network addresses. In at least one embodiment, the logic consumes a packet by performing at least one of transforming the packet, sending the packet towards a software component, sending the packet towards a physical network interface, or discarding the packet.

In at least one embodiment, identifying the plurality of packet processing stages comprises selecting at least one of the plurality of packet processing stages based on at least one of licensing status, geo-location, or a computer system attribute.

In at least one embodiment, composing the plurality of packet processing stages into the packet processing pipeline comprises at least one of determining an ordering of stages in the packet processing pipeline, or resolving a conflict.

In at least one embodiment, a particular packet processing stage comprises a packet buffer. In these embodiments, the logic of the particular packet processing stage operates on a plurality of packets stored in the packet buffer. In at least one embodiment, the logic of the particular packet processing stage performs at least one of injecting a third packet into the packet buffer, removing a fourth packet from the packet buffer, or modifying a fifth packet within the packet buffer.

In at least one embodiment, a particular packet processing stage introduces a third packet. In these embodiments, the particular packet processing stage outputs the third packet upstream on the packet processing pipeline. In at least one embodiment, the third packet is received at a prior packet processing stage and the logic of the prior packet processing stage is applied to consume the third packet by the prior packet processing stage, or output the third packet upstream on the packet processing pipeline.

In at least one embodiment, for each pair of adjacent packet processing stages, connecting the respective downstream connector of the upstream packet processing stage in the pair to the respective upstream connector of the downstream packet processing stage processing stage in the pair comprises establishing a respective socket between the respective downstream connector and the respective upstream connector.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset.

1. A method, implemented at a computer system that includes a processor, for applying a multi-stage packet processing pipeline to a single tunnel interface, the method comprising:
identifying a single tunnel interface that is associated with an operating environment of the computer system;
identifying a plurality of packet processing stages, and for each packet processing stage:
identifying at least one rule specifying packets to which the packet processing stage applies, and
identifying logic configured to process each packet received by the packet processing stage; and
composing the plurality of packet processing stages into a packet processing pipeline, including:
identifying a union of rules specifying packets to which the plurality of packet processing stages apply;
registering the union of rules with the single tunnel interface; and
arranging the plurality of packet processing stages into a linear pipeline, including:
connecting an upstream connector of an initial packet processing stage to the single tunnel interface, and
for each pair of adjacent packet processing stages, connecting a respective downstream connector of an upstream packet processing stage in the pair to a respective upstream connector of a downstream packet processing stage processing stage in the pair.

2. The method of claim 1, wherein the method also comprises consuming a first packet received by the initial packet processing stage from the tunnel interface at the initial packet processing stage.

3. The method of claim 1, wherein the method also comprises outputting a second packet received by the initial packet processing stage from the tunnel interface downstream on the packet processing pipeline.

4. The method of claim 2, further comprising:
receiving the first packet at a subsequent packet processing stage; and
applying the logic of the subsequent packet processing stage to consume the first packet by the subsequent packet processing stage, or output the first packet downstream on the packet processing pipeline.

5. The method of claim 1, wherein identifying the plurality of packet processing stages comprises identifying the plurality of packet processing stages from a single application.

6. The method of claim 1, wherein identifying the plurality of packet processing stages comprises identifying the plurality of packet processing stages from a plurality of applications.

7. The method of claim 1, wherein each rule identifies at least one network address range, and wherein the union of rules identifies a union of a plurality of ranges of network addresses.

8. The method of claim 1, wherein the logic consumes a packet by performing at least one of:
transforming the packet;
sending the packet towards a software component;
sending the packet towards a physical network interface; or
discarding the packet.

9. The method of claim 1, wherein identifying the plurality of packet processing stages comprises selecting at least one of the plurality of packet processing stages based on at least one of licensing status, geo-location, or a computer system attribute.

10. The method of claim 1, wherein composing the plurality of packet processing stages into the packet processing pipeline comprises at least one of determining an ordering of stages in the packet processing pipeline, or resolving a conflict.

11. The method of claim 1, wherein a particular packet processing stage comprises a packet buffer, and wherein the logic of the particular packet processing stage operates on a plurality of packets stored in the packet buffer.

12. The method of claim 11, wherein the logic of the particular packet processing stage performs at least one of:
injecting a third packet into the packet buffer;
removing a fourth packet from the packet buffer; or
modifying a fifth packet within the packet buffer.

13. The method of claim 1, wherein a particular packet processing stage introduces a third packet, and wherein the particular packet processing stage outputs the third packet upstream on the packet processing pipeline.

14. The method of claim 13, further comprising:
receiving the third packet at a prior packet processing stage; and
applying the logic of the prior packet processing stage to consume the third packet by the prior packet processing stage, or output the third packet upstream on the packet processing pipeline.

15. The method of claim 1, wherein, for each pair of adjacent packet processing stages, connecting the respective downstream connector of the upstream packet processing stage in the pair to the respective upstream connector of the downstream packet processing stage processing stage in the pair comprises establishing a respective socket between the respective downstream connector and the respective upstream connector.

16. A computer system for applying a multi-stage packet processing pipeline to a single tunnel interface, comprising:
a processor; and
a computer storage medium that stores computer-executable instructions that are executable by the processor to at least:
identify a single tunnel interface that is associated with an operating environment of the computer system;
identify a plurality of packet processing stages, and for each packet processing stage:
identify at least one rule specifying packets to which the packet processing stage applies, and
identify logic configured to process each packet received by the packet processing stage; and
compose the plurality of packet processing stages into a packet processing pipeline, including:
identifying a union of rules specifying packets to which the plurality of packet processing stages apply;
registering the union of rules with the single tunnel interface; and
arranging the plurality of packet processing stages into a linear pipeline, including:
connecting an upstream connector of an initial packet processing stage to the single tunnel interface, and
for each pair of adjacent packet processing stages, connecting a respective downstream connector of an upstream packet processing stage in the pair to a respective upstream connector of a downstream packet processing stage processing stage in the pair.

17. The computer system of claim 16, the computer-executable instructions also executable by the processor to consume a first packet received by the initial packet processing stage from the tunnel interface at the initial packet processing stage.

18. The computer system of claim 16, the computer-executable instructions also executable by the processor to output a second packet received by the initial packet processing stage from the tunnel interface downstream on the packet processing pipeline.

19. The computer system of claim 16, wherein identifying the plurality of packet processing stages comprises identifying the plurality of packet processing stages from a single application.

20. A computer-readable storage media that stores computer-executable instructions that are executable by a processor to apply a multi-stage packet processing pipeline to a single tunnel interface, the computer-executable instructions including instructions that are executable by the processor to at least:
identify a single tunnel interface that is associated with an operating environment of a computer system;
identify a plurality of packet processing stages, and for each packet processing stage:
identify at least one rule specifying packets to which the packet processing stage applies, and
identify logic configured to process each packet received by the packet processing stage; and
compose the plurality of packet processing stages into a packet processing pipeline, including:
identifying a union of rules specifying packets to which the plurality of packet processing stages apply;
registering the union of rules with the single tunnel interface; and
arranging the plurality of packet processing stages into a linear pipeline, including:
connecting an upstream connector of an initial packet processing stage to the single tunnel interface, and
for each pair of adjacent packet processing stages, connecting a respective downstream connector of an upstream packet processing stage in the pair to a respective upstream connector of a downstream packet processing stage processing stage in the pair.
